(19) United States
(12) Patent Application Publication
(10) Pub. No.: US 2019/0026733 A1
(43) Pub. Date: Jan. 24, 2019

(54) METHODS FOR ELECTRONIC STORAGE AND EXCHANGE OF FUNDS AND DEVICES THEREOF

(71) Applicant: Michael van Bemmelen, Teaneck, NJ (US)

(72) Inventor: Michael van Bemmelen, Teaneck, NJ (US)

(21) Appl. No.: 15/657,712

(22) Filed: Jul. 24, 2017

(51) Int. Cl. G06Q 20/38; G06Q 40/04

(52) U.S. Cl. CPC G06Q 20/382; G06Q 40/04

(57) ABSTRACT

Methods, devices, and computer readable media for electronic storage and exchange of funds include receiving a user transfer request to transfer a fund amount from a fund register stored on the user fund storage and exchange computing device to a third-party computing device. The fund register is associated with an electronic payment network. Whether the third-party computing device is associated with the electronic payment network is determined. The fund amount is transferred directly to the third-party computing device when the third-party computing device is associated with the electronic payment network to provide an electronic fund exchange.

### FIELD

This technology relates to methods, devices, and non-transitory computer readable media for the electronic storage and exchange of funds. More specifically, this technology relates to methods that provide the ability to transact electronically without using existing bank or card networks, in a secure and regulatory-compliant distributed ledger environment.

### BACKGROUND

The elite group of credit-card issuing companies sets attractive rates for very large-volume merchants. Small business owners, who pay higher rates, effectively subsidize their larger competitors. Thus the cartel of card companies imposes a regressive tax on the economy.

The market share of the card cartel continues to grow, as the Federal Reserve reported in 2016: “Card payments, including debit and credit card payments, grew to 103.3 billion with a value of $5.72 trillion in 2015, up 19.9 billion or $1.07 trillion since 2012. Card payments grew at an annual rate of 7.4 percent by number or 7.1 percent by value, from 2012 to 2015. In 2015, the number of card payments comprised over two-thirds of all noncash payments.”

A particularly profitable product for the card companies is the prepaid or stored-value card. This product, geared towards individuals who do not have a bank account, carries high fees on all types of use; some issuers even charge fees each time the balance is checked by the owner of the funds. Contrary to its name, the card stores no value, but holds merely identifying information, so that funds stored in an account controlled by the card company can be accessed. The stored-value card is thus in no way a cheaper alternative for more traditional debit or credit cards. Technology companies are creating electronic wallets to store the information of these prepaid cards on devices, and similarly mislabel these devices as “stored value devices.”

While cash would be an obvious alternative to card payments, security and other considerations make physical currency a disappearing item from the U.S. economy, and from several other countries. Onerous and time-consuming reporting requirements, as well as bank fees, are imposed on small business customers for making “excessive” amounts of cash deposits. At the same time, many banks charge ATM fees to consumers trying to withdraw cash from their own accounts.

Central banks, including the Federal Reserve, created a conundrum. The banking system, with the card companies it spawned, has a near-monopoly on the payment system. Even worse, it is impossible to store large amounts of value—in excess of the FDIC guarantee—without taking on default risk of the bank holding the account. The fact that almost all significant banks are considered too-big-to-fail further weakens the banking system.

Creating a payment system that operates independently from the banks, and an independent method of electronic storage of value would benefit competition in the financial sector and strengthen it. Thus, a distributed ledger for transactions with direct issuance of digital currency to citizens could be beneficial to central banks in many countries. Unfortunately early adopters of the distributed ledger technology include tax evaders, persons evading Anti Money Laundering laws, and cyber extortionists. This is not surprising, because the central objective of cyber-currency developers is promoting extreme privacy and reduction of government oversight of the ecommerce economy. A more productive focus would be to create currencies that promote competition to the banks and to the card-issuing cartels.

Moreover, crypto-currencies dependent on distributed ledger technology will not become a viable alternative on “Main Street USA” to card payments for several reasons: (i) the dollar is abandoned as unit of account, which results in extreme fluctuations of the new currency value; (ii) authorities have expressed strong objections to, and actively prevent, acceptance in view of potential money laundering and tax evasion; (iii) complexity of the schemes and their security hinder acceptance by the general public; (iv) methods to bring currency in circulation create an unfair advantage for a technologically savvy elite—ironically labeled “miners”; (v) absence of a central administrator may actually reduce security, as is revealed by several well-publicized cyber break-ins of crypto-currency exchanges; (vi) the completely decentralized nature of the fully distributed ledger slows transaction speeds and make it unfit for point-of-sale transactions; and (vii) the absence of a trustee or sponsor may lead to chaos when crypto-currencies have to migrate improved platforms or to the next level of encryption—an unavoidable event in a world governed by Moore's law.

The present technology is directed to overcoming these and other deficiencies in the art.

### SUMMARY

A method for providing electronic fund storage and exchange includes receiving, by a user fund storage and exchange management computing device, a user transfer request to transfer a fund amount from a fund register stored on the user fund storage and exchange computing device to a third-party computing device. The fund register is associated with an electronic payment network. Whether the third-party computing device is associated with the electronic payment network is determined. The fund amount is transferred directly to the third-party computing device when the third-party computing device is associated with the electronic payment network to provide an electronic fund exchange.

A user fund storage and exchange management computing device, comprising a processor and a memory coupled to the processor which is configured to execute one or more programmed instructions comprising and stored in the memory to receive a user transfer request to transfer a fund amount from a fund register stored on the user fund storage and exchange computing device to a third-party computing device. The fund register is associated with an electronic payment network. Whether the third-party computing device is associated with the electronic payment network is determined. The fund amount is transferred directly to the third-party computing device when the third-party computing device is associated with the electronic payment network to provide an electronic fund exchange.

A non-transitory computer readable medium having stored thereon instructions for providing electronic fund storage and exchange comprising executable code which when executed by a processor, causes the processor to perform steps including receiving a user transfer request to transfer a fund amount from a fund register stored on the user fund storage and exchange computing device to a third-party computing device. The fund register is associated with an electronic payment network. Whether the third-party computing device is associated with the electronic payment network is determined. The fund amount is transferred directly to the third-party computing device when the third-party computing device is associated with the electronic payment network to provide an electronic fund exchange.

The present technology provides an open platform for storing and exchanging funds without the need for brokers selling processing services. This allows for lower fees than traditional fund exchange services, such as credit cards or smart phone wallets. Further, no authorization is required. Transactions occur device-to-device and an encrypted register prevents double spending. Advantageously, the technology allows for immediate spending of transferred funds by merchants who receive funds through the technology. The technology provides enhanced privacy because sharing of the distributed transaction ledger is limited. Also, the exchanges are fully compliant across jurisdictions with relevant laws. No new currency is necessary to use the technology as a central bank can adopt the electronic fund technology and create electronic tender in its own currency. Finally, the technology provides enhanced security as a lost device cannot be accessed without authorization and there is no unencrypted data storage, which reduces opportunities for fraud.

The present technology provides a number of advantages, including providing more efficient methods, devices, and non-transitory computer readable media for the electronic storage and exchange of funds. The present technology advantageously allows consumers and merchants to transact off the grid of card issuers, while retaining the security and convenience of electronic transactions in a distributed ledger environment.

### BRIEF DESCRIPTION OF THE DRAWINGS

FIG. 1 is a block diagram of an exemplary environment including a user fund storage and exchange management computing device.

FIG. 2 is a block diagram of an example of the user fund storage and exchange management computing device.

FIG. 3 is a flowchart of an exemplary method of electronically storing and exchanging monetary funds of the present technology.

### DETAILED DESCRIPTION

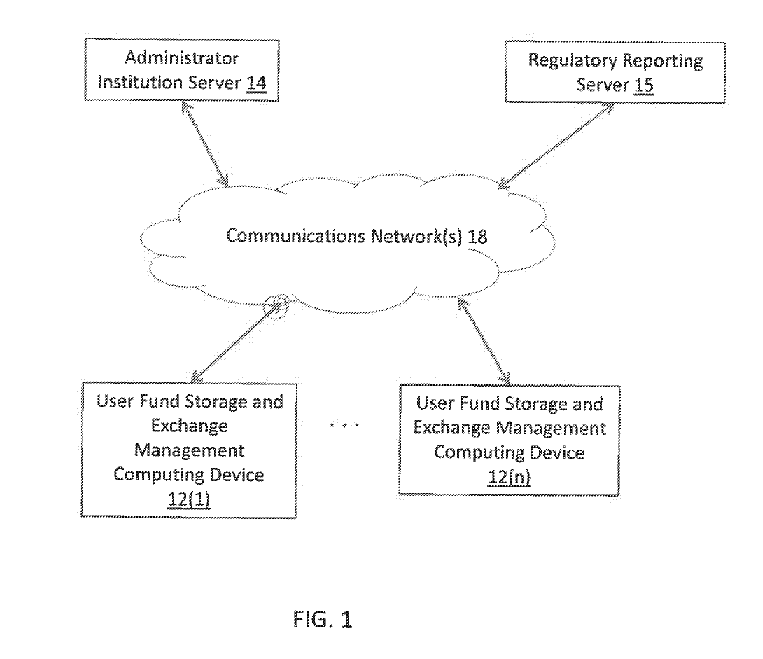

FIG. 1 illustrates an environment 10 with a plurality of user fund storage and exchange management computing devices 12(1)-12(n) connected to an administrating institution server 14 and a regulatory reporting server 15 via communication network(s) 18 to provide a secure and responsive environment for storing and exchanging funds. The funds moving around environment 10 consist of encrypted pieces of information as described by Chaum, “Blind Signatures for Untraceable Payments,” Advances in Cryptology Proceedings of Crypto., 82(3): 199-203, (1983), and U.S. Pat. No. 4,759,063, the disclosures of which are hereby incorporated herein by reference in their entirety. Although an exemplary environment 10 is described, the environment 10 can include any other number and types of systems, devices, components, and elements connected together in other configurations with other types and numbers of communications networks. This technology provides a number of advantages including ability to transact off the grid of the card companies and avoid the transaction “tax” levied by these networks. At the same time, data for regulatory and tax authorities is preserved and reported; and card-less transactions become a realistic alternative currency.

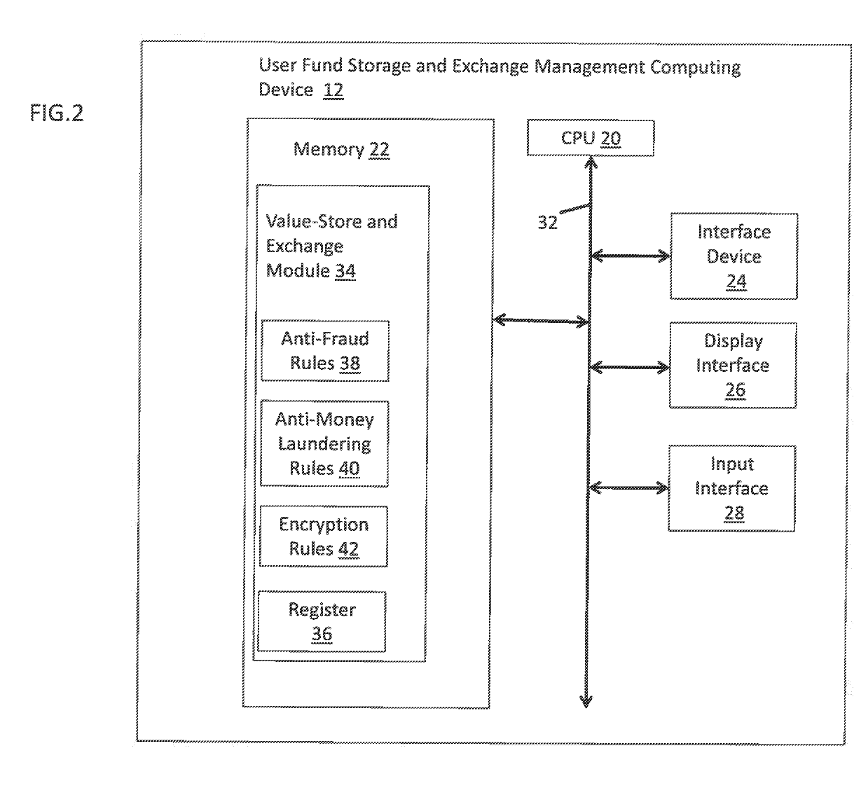

The user fund storage and exchange management computing devices 12(1)-12(n) may be mobile and/or smart phones, although the user fund storage and exchange management computing devices 12(1)-12(n) can comprise other types and numbers of devices, such as a tablet computing devices, PDAs, minicomputers, desktop computing devices, and/or laptop computing devices, by way of example only. Referring more specifically to FIG. 2, an exemplary user fund storage and exchange management computing device 12(1) includes a central processing unit (CPU) or processor 20, a memory 22, an interface device 24, a display interface 26, and an input interface 28 which may be a separate input or a touchscreen on the display interface 26, all of which are coupled together by a bus 32 or other link, although the funds-storing and exchange computing device 12(1) may contain any other number and types of devices, components, and elements in other configurations. Although exemplary user fund storage and exchange management computing device 12(1) is described it is to be understood that other user fund storage and exchange management computing devices with similar components may be employed in the methods of the present technology.

The processor 20 in the user fund storage and exchange management computing device 12(1) executes a program of stored instructions, or derives the program of stored instructions through an initial set of conditions and machine learning, for one or more aspects of the present technology as described and illustrated by way of examples herein, although other types and numbers of processing devices and logic could be used and the processor 20 could execute other numbers and types of programmed or learned instructions.

The memory 22 in the user fund storage and exchange management computing device 12(1) may store the programmed instructions for one or more aspects of the present technology as described and illustrated herein, although some or all of the programmed instructions could be stored and executed elsewhere. A variety of different types of memory storage devices, such as random access memory (RAM) or a read only memory (ROM) in the system or a hard disk, CD ROM, DVD ROM, or other computer readable medium which is read from and written to by a magnetic, optical, or other reading and writing system that is coupled to the processor 20, can be used for the memory 22. The memory 22 in the user fund storage and exchange management computing device 12 may store programmed instructions for performing one or more aspects of the present technology described and illustrated in more detail below.

In one example, the memory 22 retains a funds-store and exchange module 34 for performing one or more aspects of the present technology described and illustrated herein. Referring again to FIGS. 1-2, the funds-store and exchange module 34 includes a register 36 that tracks the funds the user has accumulated through a financial institution associated with administrator institution portal 14 and transferred to the user fund storage and exchange management computing device 12(1). As more fully described in the above-referenced U.S. Pat. No. 4,759,063, the user's device 12(1) contains the private key in register 36 to receive electronic currency brought in circulation by the institution, which may issue the public keys, and accesses administrator institution portal 14. Previous art could not prevent double spending without relying on a distributed ledger (block-chain). The proposed technology prevents double spending by (i) receiving and storing electronic currency in the protected register 36, which prevents copying; and (ii) by requiring deletion of the currency from the register of the user when spending it.

Each time the user authorizes a purchase, programmed instructions stored on memory 22 which collectively define the working of register 36 cause funds from the user's balance to be deducted from the register 36 and transfers the funds to a register associated with the seller, such as a register stored on one of the additional user fund storage and exchange management computing devices 12(2) . . . 12(n) illustrated in FIG. 1, by way of communication network(s) 18. The actual method of communication can include NFC, Internet connection, or in case the seller lacks the current technology, the transfer may involve the administrator institution server 14 and more traditional forms of fund transfer, such as electronic check or instantaneous bank transfer.

In one example, the funds-store and exchange module 34 may also include one or more rules from administrator institution server 14. The one or more rules may include, by way of example only, anti-fraud rules 38 and anti money-laundering rules 40, although other sets of rules may be stored and employed by the funds-store and exchange module 34. The administrator associated with the administrator institution server 14 generate an anti money-laundering underwriting framework that is embodied within the anti-money laundering rules 40 stored in the funds-store and exchange module of 34 of the user fund storage and exchange management computing device 12(1). The anti-money laundering rules 40 receive input data such as: (i) know-your-customer information requirements; (ii) size and frequency of deposits; (iii) size and frequency of transactions; (iv) identity of users involved in fund transfers, by way of example only. A unique aspect of the technology is that the device itself ensures enforcement of all applicable regulations by incorporating the anti-money laundering rules 40 in its protected funds-store and exchange module 34. When a user spends the funds, the receiver has two choices: (i) the receiver accepts the funds using the same technology and the anti-money laundering rules 40 follow the funds to the new device 12(2), or, alternatively, (ii) the receiver can opt for an instantaneous transfer to an account held at an institution subject to regulatory supervision.

Additional protection to the administrator associated with the administrator institution server 14 and the user is provided by the anti-fraud rules 38, which are incorporated in the funds store and exchange module 34. Examples of anti-fraud rules 38 may include multi-factor authorization of the user, and/or authentication of an internet seller before funds are transferred, by way of example only.

The funds-store and exchange module 34 further includes encryption rules 42 for securely handling transactions and balances. In this example, the consumer utilizing user fund storage and exchange management computing device 12(1) can access the funds-store and exchange module 34 only by fingerprint or facial recognition or similar authentication through a security input device configured to interact with the input interface 28 on the user fund storage and exchange management computing device 12(1) as described below. While the consumers have access to transfer funds and authorize transactions into the funds store and exchange module 34, they cannot override the account balance stored in the register 36 of the funds store and exchange module 34 as described in U.S. Patent Application No. 2010/0077230, the disclosure of which is hereby incorporated herein by reference in its entirety. The funds-store and exchange module 34 further transmits transaction data, by way of example, to administrator institution server 14 over the communication network(s) 18. Certain trusted parties among the users with devices 12(2)-12(n) may perform the functions of administrator and may receive information over the communication network(s) 18 through access to a shared (distributed) ledger, memorializing transactions. In another example, funds-store and exchange module 34 reports, by way of communications network(s) 18 and regulatory reporting server 15, transaction data directly to authorities regulating the exchange or transfer of funds, or taxation thereof.

Referring again to FIG. 1-2, the interface device 24 in the user fund storage and exchange management computing device 12(1) operatively couples and communicates between the additional user fund storage and exchange management computing devices, the administrator institution server 14, which are all coupled together by the communication network(s) 18, although other types and/or numbers of communication networks or systems with other types and/or numbers of connections and/or configurations to other devices and/or elements can also be used.

By way of example only, the communication network(s) 18 can include near field communication (NFC), local area network(s) (LAN(s)) or wide area network(s) (WAN(s)), and can use TCP/IP over Ethernet and industry-standard protocols, although other types and/or numbers of protocols and/or communication networks can be used. The communication network(s) 18 in this example can employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The display interface 26 and the input interface 28 of the user fund storage and exchange management computing device 12(1) enable a user, such as an user or an administrator, to interact with the user fund storage and exchange management computing device 12(1), such as to input and/or view data and/or to configure, program and/or operate it by way of example only. Display devices configured to interact with the display interface 26 may include a computer monitor or touch screen device, while input devices configured to interact with the input interface 28 may include a keyboard, computer mouse, and/or touch screen, although other types and numbers of display and/or input interfaces could also be used in other examples. In one example, the input interface 28 is configured to interact with a finger print scanner or a built-in camera in the user fund storage and exchange management computing device 12(1) for facial or iris recognition. The input interface 28 enables a user to securely access certain elements or functionalities of the user fund storage and exchange management computing device 12(1), such as the funds-store and exchange module 34.

The administrator institution server 14 may be hardware or software or may represent a system with multiple server computing devices in a server pool, which may include internal or external networks. The user fund storage and exchange management computing devices 12(1)-12(n) may be linked to each other and to servers through the Internet, through NFC technology, telecom company networks, or similar connection. In this example the server devices may be any version of Microsoft® IIS servers or Apache® servers, although other types of server computing devices may be used. Further, additional server computing devices may be coupled to the communication network(s) 18 and many different types of applications may be available on each of the server computing devices. The administrator using administration institution server 14 can maintain a semi-private ledger shared only with regulators, or could at the other extreme, distribute the ledger without any permission limitations. The complete flexibility of the environment allows for unknown administrators to launch the compliant electronic currency relying on a distributed ledger for transparency. Using the same environment 10 and technology, a central bank could sponsor the electronic currency and enhance efficiency of the environment by limiting the number of nodes, and function as the administrator.

The regulatory reporting server 15 may be hardware or software or may represent a system with multiple server computing devices in a server pool, which may include internal or external networks. The user fund storage and exchange management computing devices 12(1)-12(n) may be linked to each other and to servers through the Internet, through NFC technology, telecom company networks, or similar connection. In this example the server devices may be any version of Microsoft® IIS servers or Apache® servers, although other types of server computing devices may be used. Further, additional server computing devices may be coupled to the communication network(s) 18 and many different types of applications may be available on each of the server computing devices. The regulatory reporting server 15 could be utilized, for instance, to receive and provide suspicious activity reports, OFAC hit reports, comply with other anti-money laundering requirements, as well as payment processor or money transmitter reports to the IRS and similar authorities.

Although an exemplary network environment 10 with the user fund storage and exchange management computing devices 12(1)-12(n), the administration institution server 14, the regulatory reporting server 15, and communication network(s) 18 are described and illustrated herein, other types and numbers of systems, devices, components, and elements in other topologies can be used. It is to be understood that the systems of the examples described herein are for exemplary purposes, as many variations of the specific hardware and software used to implement the examples are possible, as will be appreciated by those skilled in the relevant art(s).

In addition, two or more computing systems or devices can be substituted for any one of the systems or devices in any example. Accordingly, principles and advantages of distributed processing, such as redundancy and replication also can be implemented, as desired, to increase the robustness and performance of the devices and systems of the examples. The examples may also be implemented on computer system(s) that extend across any suitable network using any suitable interface mechanisms and network traffic technologies.

The examples may also be embodied as a non-transitory computer readable medium having instructions stored thereon for one or more aspects of the present technology as described and illustrated by way of the examples herein, as described herein, which when executed by a processor, cause the processor to carry out the steps necessary to implement the methods of the examples, as described and illustrated herein.

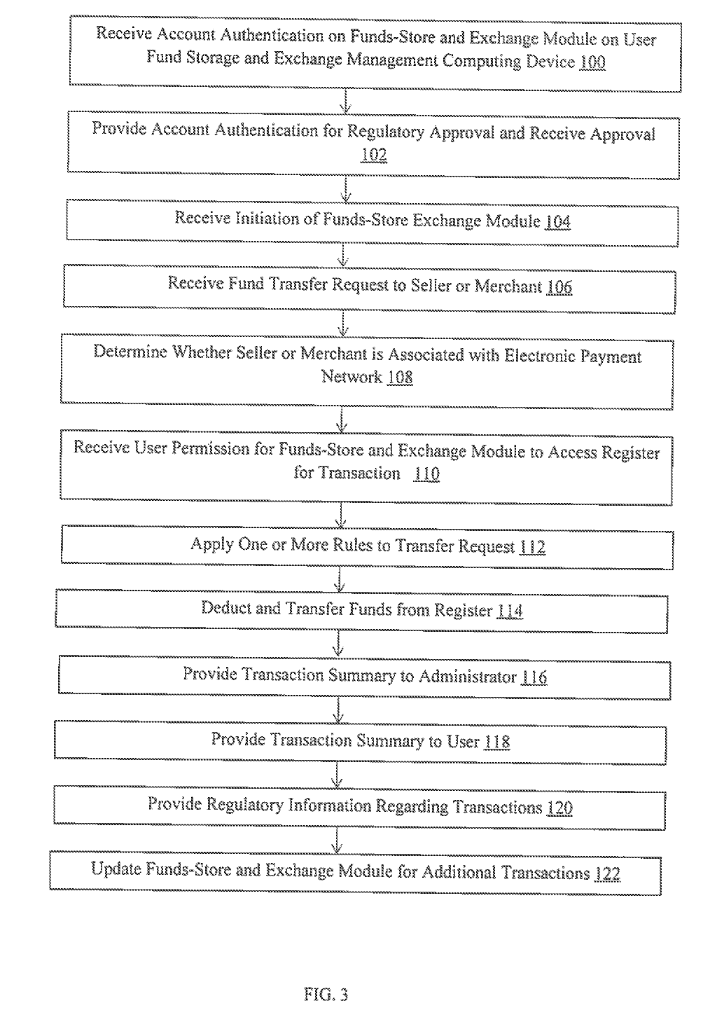

A method for storing and exchanging monetary funds will now be described with reference to FIGS. 1-3. The technology is illustrated for an example where users transfer funds to a financial institution for credit to their account and further transfer without requiring the use of the credit card networks. In another example, the financial institution using the technology could advance funds to the users as a loan. If the exemplary financial institution is the central bank, the technology would assist in creating and circulating currency, thus replacing paper money and bank deposits with digital currency.

Applying the technology for privacy and security enhancements in providing lines of credit, as described in U.S. patent application Ser. No. 15/485,014, the disclosure of which is hereby incorporated herein by reference in its entirety, would provide a particularly powerful use case for the present technology. In combining both technologies, the application for credit is made without the creditor receiving or storing confidential information. Additionally, the transactions conducted with the obtained credit are transmitted over the communication network(s) 18 in encrypted and abbreviated form. The full detail of the transaction record never leaves the user fund storage and exchange management computing device 12(1). Recent breaches of even the most secretive databases create anxiety that private transaction detail and account credentials are available to many thousands of insiders at financial institutions and at merchants.

At step 100, the user fund storage and exchange management computing device 12(1) receives an activation input from the user to activate the funds-store and exchange module 34 for the first time as part of an authorization process. The funds-store and exchange module 34 applies anti-money laundering rules 40 to authenticate the identity of the user and ascertains that there are no government issued sanctions against the person such those listed on OFAC and similar publications. By way of example, the anti-money laundering rules 40 may be received from the administrator institution server 14, although the anti-money laundering rules may be received from other devices. In one example, the user fund storage and exchange management computing device 12(1) uses a built-in camera coupled to the input interface 28 to use authentication software stored on the user fund storage and exchange management computing device 12(1) for authentication of the user's driver license, by way of example, although other techniques may be utilized for authorization of the user in conformance with government-issued regulations for payment processors or for entities transmitting or storing funds, or any other applicable regulation. Based on government-issued thresholds of usage of the user fund storage and exchange management computing device 12(1), such as received through regulatory reporting server 15 by way of example, the funds-store and exchange module 34 will differentiate between users who are deemed “consumers” and those that are deemed “merchants.” As part of the authorization process, merchants will provide tax identification numbers, by way of example to regulatory reporting server 15, so that the technology can comply with applicable reporting requirements.

In one example, in step 102, the user authorization received in step 100 is provided to a regulator associated with the regulatory reporting server 15 for at least one regulatory approval prior to the user being allowed to utilize the user fund storage and exchange management computing device 12(1) to access the electronic payment network For instance, the user's identity is checked against the US Department of Treasury database of Specially Designated Nationals (“SDN”) who are precluded from opening accounts at U.S. financial institutions. As an additional example, the regulatory reporting server 15 is connected to the FinCEN Detroit Computing Center where financial institutions have to submit Suspicious Activity Reports. In the event that regulatory approval is received, by way of example through regulatory reporting server 15, the user is authenticated to use the user fund storage and exchange management computing device 12(1) to make payments through the electronic payment network of the present technology. In the event that regulatory approval is denied, the user may not utilize the user fund storage and exchange management computing device 12(1) to access the electronic payment network.

At step 104, after the authorization process, the user fund storage and exchange management computing device 12(1) receives an activation to activate the user fund storage and exchange management computing device 12(1) itself and the funds-store and exchange module 34. By way of example, the user enters a password on an external keyboard or touch screen configured to interact with the input interface 28 of the user fund storage and exchange management computing device 12(1). In one example, the user is preapproved in step 100 to utilize the user fund storage and exchange management computing device 12(1) in accordance with know-your-customer regulations. Additionally, the user may provide a fingerprint or facial recognition authentication through a device configured to interact with the input interface 28 to unlock the user fund storage and exchange management computing device 12(1) and to activate the funds-store and exchange module 34 to provide additional security, although other security techniques may be utilized to initiate the methods of the present technology. After passing security checks, such as fingerprint recognition or inputting passwords or other unique identifiers (each a “user-recognition test”) through the input interface 28, the user can interact with the display interface 26 and the input interface 28 of the user fund storage and exchange management computing device 12(1) and the funds-store and exchange module 34. These interactions may include input and/or view data and/or to configure, program, and/or operate the funds-store and exchange computing device 12(1). Encryption of certain parts of the program, as well as the user recognition test configured to interact with the input device 28 limit the interaction between user and funds-store and exchange computing device 12(1) to authorized actions.

Next, at step 106, the user fund storage and exchange management computing device 12(1) receives a request from the user to transfer funds out of the register 36 to make a payment, for instance to a similar fund storage and exchange management device 12(2), by way of example. The request may be initiated by a user purchase using the funds-store and exchange module 34 on the user fund storage and exchange management computing device 12(1). The user enters the amount of her purchase on an input screen shown on the display interface 26 as well as the account information (e.g. identified by email address or phone number) of the seller or service provider. In this example, the register 36 is associated with an electronic payment network associated with an administrator associated with the administrator institution server 14.

Next, in step 108, the user fund storage and exchange management computing device 12(1) determines whether the seller associated with the requested funds transfer in step 106 is associated with the electronic payment network associated with the register 36 on the user fund storage and exchange management computing device 12(1). In one example, the seller has access to the same technology, thus funds will transferred from the register 36 of the buyer stored on the user fund storage and exchange management computing device 12(1) to a corresponding register of the seller stored on, by way of example, another one of the user fund storage and exchange management computing devices 12(2). The sale can take place at the seller or merchant's place of business in a POS transaction or over the internet, or can be a scheduled as a repeating payment for services, or charitable donations, by way of example, but other transactions using the present technology may be contemplated. If the seller is part of the network, the system proceeds to step 110. If the seller is not yet a participant in the electronic payment network, payments will be made electronically to the seller through the administration associated with the administrator institution server 14. The administrator, for example, can join certain instant pay networks, such as clearXchange or Zelle, or use ACH, electronic checks or other more traditional payment methods all of which are potentially cheaper than credit card use. The importance of incorporating an alternative payment method becomes clear when reviewing the history of the credit card sector. New entrants to the sector are caught in a catch-22 situation where consumers do not adopt a new card until many merchants accept it as payment method. At the same time, merchants do not adopt a new card until a critical mass of consumer is signed up. The last time the vicious circle was broken occurred during the 1980s when Discover card launched a new card at great expense.

At step 110, the user fund storage and exchange management computing device 12(1) receives user permission for the funds-store and exchange module 34 to access the register 36 stored on the user fund storage and exchange management computing device 12(1) to withdraw funds from the register 36. By way of example, the user enters an authorization for the transaction through the display interface 26 or the input interface 28 and the destination account information. As set forth above, the destination account is either a user account with access to the same technology through an administrator associated with the administrator institution server 14 or an account at a third party bank.

At step 112, the user fund storage and exchange management computing device 12(1), through the funds-store and exchange module 34 applies one or more of the anti-fraud rules 38 and anti-money laundering rules 40 to the requested transfer to ensure compliance with those rules prior to executing the funds transfer. In the event that any of the applied rules are violated the transfer request is denied to ensure compliance with regulations and to combat fraud.

Next at step 114, the funds-store and exchange module 34 on the user fund storage and exchange management computing device 12(1) deducts the funds from the register 36 of the user to update the register 36 and transfers the funds over the electronic payment network in accordance with the present technology. The funds are directed either (i) directly to the register of the seller or merchant who is receiving the funds and has access to the technology through the electronic payment network; or (ii) the funds are directed through the administrator associated with the administrator institution server 14 to the account of the seller or merchant at a third-party financial institution for further credit of the seller's account at such institution.

At step 116, the user fund storage and exchange management computing device 12(1) sends summary information of transactions back to the administrator institution server 14 over communication network(s) 18. The transaction summary includes the transferred fund amount and the updated amount on the register 36 of the user fund storage and exchange management computing device 12(1), although the transaction summary may include additional information. The transaction summary may alternatively be provided to a shared ledger for the electronic payment network. Thus the administrator retains the ability to audit the network of users and user fund storage and exchange management computing devices 12(1)-12(n) and the chain of their transactions. At the same time, less information is accumulated at merchants than for card transactions, where authorization of each transaction and details thereof are permanently stored at many of the merchants; a practice that became apparent during recent breaches of security at card issuers.

Next, at step 118, the funds-store and exchange module 34 of the user fund storage and exchange management computing device 12(1) provides a transaction summary including the balance of the register 36 and detailed transaction information to the user in their preferred format, for instance by email, as incoming text, or for display on the display interface 26 of the user fund storage and exchange management computing device 12(1). In addition to the transaction summary, the funds-store and exchange module 34 may provide select end-of-week or end-of-month reports in a format selected by the user. The preferred settings will remain the default until changed by the user.

At step 120, for merchants utilizing the user fund storage and exchange management computing device 12(1), the user fund storage and exchange management computing device 12(1) provides information to comply with one or more regulatory requirements on payment processors to submit forms, for example such as form 1099 and similar, to tax authorities. Annual aggregate amounts received by merchants among users of the user fund storage and exchange management computing device 12(1) are sent by communication network(s) 18, by way of example to regulatory reporting server 15, to authorities such as IRS or other relevant entities. Transaction data may be stored and compiled in the memory 22 of the user fund storage and exchange management computing device 12(1) in order to facilitate providing the information required to satisfy the one or more regulatory reporting requirements.

At step 122, the funds-store and exchange module 34 will reset for additional transactions, learning from experience of other users across the communication network(s) 18. By way of example, the anti-fraud rules 38 can be updated through this network and through machine learning to provide additional protection by geo-location services for transactions with remote sellers, or any other fraud protection services available for internet commerce generally.

Accordingly, the present technology provides a number of advantages including providing an open platform for storing and exchanging funds without the need for brokers selling processing services.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for providing electronic fund storage and exchange comprising:
receiving, by a user fund storage and exchange management computing device, a user transfer request to transfer a fund amount from a fund register stored on the user fund storage and exchange computing device to a third-party computing device, wherein the fund register is associated with an electronic payment network;
determining, by the user fund storage and exchange management computing device, whether the third-party computing device is associated with the electronic payment network; and
transferring, by the user fund storage and exchange management computing device, the fund amount directly to the third-party computing device when the third-party computing device is associated with the electronic payment network to provide an electronic fund exchange.

2. The method of claim 1 further comprising:
updating, by the user fund storage and exchange management computing device, the fund register based on the transferred fund amount; and
providing, by the user fund storage and exchange management computing device, a transaction summary comprising the transferred fund amount and the updated fund register data to an administrator or the shared ledger of the electronic payment network.

3. The method of claim 1 further comprising:
displaying, by the user fund storage and exchange management computing device, the transaction summary on a display interface of the user fund storage and exchange management computing device.

4. The method of claim 1 further comprising:
receiving, by the user fund storage and exchange management computing device, a user authentication to access the fund register prior to receiving the user transfer request.

5. The method of claim 1 further comprising:
providing, by the user fund storage and exchange management computing device, the user authentication to a regulatory server device for at least one regulatory approval; and
receiving, by the user fund storage and exchange management computing device, at least one regulatory approval from the regulatory server device prior to receiving the user transfer request.

6. The method of claim 1 further comprising:
applying, by the user fund storage and exchange management computing device, one or more anti-money laundering rules or anti-fraud rules stored on the user fund storage and exchange management computing device to receive the user transfer request prior to transferring the fund amount to the third-party computing device.

7. The method of claim 1 further comprising:
transferring, by the user fund storage and exchange management computing device, the fund amount to the third-party computing device through an administrator of the payment network when the third-party computing device is not associated with the electronic payment network to provide the electronic fund exchange.

8. A user fund storage and exchange management computing device, comprising a processor and a memory coupled to the processor which is configured to execute one or more programmed instructions comprising and stored in the memory to:
receive a user transfer request to transfer a fund amount from a fund register stored on the user fund storage and exchange computing device to a third-party computing device, wherein the fund register is associated with an electronic payment network;
determine whether the third-party computing device is associated with the electronic payment network; and
transfer the fund amount directly to the third-party computing device when the third-party computing device is associated with the electronic payment network to provide an electronic fund exchange.

9. The device of claim 8, wherein the processor coupled to the memory is further configured to execute at least one additional programmed instruction comprising and stored in the memory to:
update the fund register based on the transferred fund amount; and
provide a transaction summary comprising the transferred fund amount and the updated fund register data to an administrator or the shared ledger of the electronic payment network.

10. The device of claim 8, wherein the processor coupled to the memory is further configured to execute at least one additional programmed instruction comprising and stored in the memory to:
display the transaction summary on a display interface of the user fund storage and exchange management computing device.

11. The device of claim 8, wherein the processor coupled to the memory is further configured to execute at least one additional programmed instruction comprising and stored in the memory to:
receive a user authentication to access the fund register prior to receiving the user transfer request.

12. The device of claim 8, wherein the processor coupled to the memory is further configured to execute at least one additional programmed instruction comprising and stored in the memory to:
provide the user authentication to a regulatory server device for at least one regulatory approval; and
receive at least one regulatory approval from the regulatory server device prior to receiving the user transfer request.

13. The device of claim 8, wherein the processor coupled to the memory is further configured to execute at least one additional programmed instruction comprising and stored in the memory to:
apply one or more anti-money laundering rules or anti-fraud rules stored on the user fund storage and exchange management computing device to receive the user transfer request prior to transferring the fund amount to the third-party computing device.

14. The device of claim 8, wherein the processor coupled to the memory is further configured to execute at least one additional programmed instruction comprising and stored in the memory to:
transfer the fund amount to the third-party computing device through an administrator of the payment network when the third-party computing device is not associated with the electronic payment network to provide the electronic fund exchange.

15. A non-transitory computer readable medium having stored thereon instructions for providing electronic fund storage and exchange comprising executable code which when executed by a processor, causes the processor to perform steps comprising:
receiving a user transfer request to transfer a fund amount from a fund register stored on the user fund storage and exchange computing device to a third-party computing device, wherein the fund register is associated with an electronic payment network;
determining whether the third-party computing device is associated with the electronic payment network; and
transferring the fund amount directly to the third-party computing device when the third-party computing device is associated with the electronic payment network to provide an electronic fund exchange.

16. The medium of claim 15 further having stored thereon at least one additional instruction that when executed by the processor causes the processor to perform at least one additional step comprising:
updating the fund register based on the transferred fund amount; and
providing a transaction summary comprising the transferred fund amount and the updated fund register data to an administrator or the shared ledger of the electronic payment network.

17. The medium of claim 15 further having stored thereon at least one additional instruction that when executed by the processor causes the processor to perform at least one additional step comprising:
displaying the transaction summary on a display interface of the user fund storage and exchange management computing device.

18. The medium of claim 15 further having stored thereon at least one additional instruction that when executed by the processor causes the processor to perform at least one additional step comprising:
receiving a user authentication to access the fund register prior to receiving the user transfer request.

19. The medium of claim 15 further having stored thereon at least one additional instruction that when executed by the processor causes the processor to perform at least one additional step comprising:
providing the user authentication to a regulatory server device for at least one regulatory approval; and
receiving at least one regulatory approval from the regulatory server device prior to receiving the user transfer request.

20. The medium of claim 15 further having stored thereon at least one additional instruction that when executed by the processor causes the processor to perform at least one additional step comprising:
applying one or more anti-money laundering rules or anti-fraud rules stored on the user fund storage and exchange management computing device to the receive user transfer request prior to transferring the fund amount to the third-party computing device.

21. The medium of claim 15 further having stored thereon at least one additional instruction that when executed by the processor causes the processor to perform at least one additional step comprising:
transferring the fund amount to the third-party computing device through an administrator of the payment network when the third-party computing device is not associated with the electronic payment network to provide the electronic fund exchange.
